(19) United States
(12) Patent Application Publication
(10) Pub. No.: US 2004/0120037 A1
(43) Pub. Date: Jun. 24, 2004

(54) Rear projection screen, optical component thereof, and method for manufacturing the optical component

(76) Inventors: Jen-Huai Chang, Changhua (TW); Jyh-Horng Wang, Taipei (TW); Chiang Hsing Liu, Miaoli (TW)

Correspondence Address: BIRCH STEWART KOLASCH & BIRCH, PO BOX 747, FALLS CHURCH, VA, 22040-0747, US

(21) Appl. No.: 10/409,206

(22) Filed: Apr. 9, 2003

(30) Foreign Application Priority Data
Dec. 18, 2002 (TW) 091136456

(51) Int. Cl. G03B 21/60

(52) U.S. Cl. 359/456

(57) ABSTRACT

A rear projection screen includes a first optical component and a second optical component adjacent to the first optical component. In this case, the second component has a first surface and a second surface opposite to the first surface, and a plurality of cylindrical convex portions are respectively formed on both surfaces. A plurality of concave portions corresponding to the cylindrical convex portions of the first surface are respectively formed between the cylindrical convex portions of the second surface. A light absorbing material is applied to each concave part. Furthermore, the invention also provides an optical component used in the rear projection screen and a method for manufacturing the optical component.

### BACKGROUND OF THE INVENTION

1. Field of Invention

The invention relates to a screen, an optical component used in the screen, and a method for manufacturing the optical component and, in particular, to a rear projection screen, an optical component used in the rear projection screen, and a method for manufacturing the optical component.

2. Related Art

As the acceptance of HDTVs and DVD players has grown widespread, the image quality of large size displays has become increasingly important. In large size displays, projection displays, including rear projection displays, have become some of the most popular display technologies of all time. In a rear projection display, a rear projection screen is mainly used for screening images and is characterized by its large size, high quality, and light and thin composition. Therefore, when designing a rear projection screen, people skilled in the art should consider the brightness of view angles, the contrast and resolution of images, and the likes.

Recently, as a result of the development in LCD, DLP (Digital Light Processing), and LCOS (Liquid-Crystal-on-Silicon) technologies, the resolution and brightness of projection displays have increased considerably. Accordingly, the image quality has improved substantially. The CRT display method, however, is still the most developed display technology and because of its low price, so CRT technology comprises the majority of the display market. In general, CRT displays have several drawbacks such as lower brightness, lower resolution, and chromatic aberration problems. In projection displays, light diffusing sheets are provided so as to solve the chromatic aberration problems. The light diffusing sheet employs cylindrical lenses on opposite sides of the sheet, and is doped with light diffusing beads which increase the view angle. With reference to FIGS. 1A and 1B, U.S. Pat. No. 5,870,224 disclosed a rear projection screen 1 includes a Fresnel lens 10 and a lenticular lens 11.

In this case, the lenticular lens 11 has a first surface 110 and a second surface 111, which respectively have a plurality of cylindrical convex portions 110a and 111a. The second surface 111 further has a plurality of stripe convex portions 111b positioned between each cylindrical convex portion 111a, respectively. A light absorbing layer 120 is applied to each stripe convex portion 111b for absorbing interference and scattered light in the environment. Moreover, the lenticular lens 11 may contain light diffusing beads 130 for increasing the view angle of rear projection screen 1. However, in this structure, when an incident light 1000 passes through the first surface 110, focuses on the second surface 111 (point P) and is scattered out of the lenticular lens 11, the light absorbing layers 120 might block the scattered light 1001. Thus, the brightness of the rear projection screen 1 is induced. Accordingly, the width and height of light absorbing layers 120 are limited. It should be noted that if the thickness of lenticular lens 11 is inaccurate during manufacturing processes, the incident light 1000 may not accurately focus on the second surface 111. If this is the case, the brightness of rear projection screen 1 is further induced, and the width of light absorbing layer 120 must be further contracted to overcome this problem.

In addition, as shown in FIG. 1C, since the width of light absorbing layer 120 is limited, the interference light 1002 may penetrate part of the second surface 111 without being absorbed by light absorbing layers 120. Then, the light will in turn be reflected as the reflecting light 1003 from the lenticular lens 11 through part of the second surface 111 without light absorbing layers 120. This may cause a decrease in the contrast and resolution of the rear projection screen 1. Moreover, when manufacturing the rear projection screen 1, since the light absorbing layers 120 are formed on the stripe convex portions 11b of lenticular tens 11, extra care must be taken with the planarity of the stripe convex portions 11b and with the application of pressure control. Thus, applying the light absorbing layers 120 is proved to be a bottleneck in improving the manufacturing yield.

As mentioned above, it is an important subjective of the invention to improve the brightness, contrast and resolution of a rear projection screen.

### SUMMARY OF THE INVENTION

In view of the previously mentioned problems, an objective of the invention is to provide a rear projection screen, which has improved brightness, contrast and resolution.

It is another objective of the invention to provide an optical component used in a rear projection screen, which has improved brightness, contrast and resolution.

It is yet another objective of the invention to provide a method for manufacturing an optical component used in a rear projection screen, which has improved brightness, contrast and resolution.

The invention is characterized by providing a plurality of concave portions between each cylindrical convex portion of an optical component used in a rear projection screen. Each concave portion is further applied with a light absorbing material to absorb interference and scattered light from the environment. Moreover, the area of each concave portion is enlarged, so that the contrast and resolution of the rear projection screen are improved.

To achieve the above-mentioned objective, the invention provides a rear projection screen including a first optical component and a second optical component adjacent to the first optical component. The second optical component has a first surface and a second surface opposite to the first surface. The first surface and the second surface respectively have a plurality of cylindrical convex portions, the second surface further has a plurality of concave portions, each of the which is formed between the cylindrical convex portions of the second surface and is provided corresponding to the cylindrical convex portions of the first surface. In addition, a light absorbing material is applied to each of the concave portions. Furthermore, the invention also provides an optical component used in the rear projection screen, which is similar to the mentioned second optical component.

The invention also discloses a method for manufacturing an optical component, including the following steps. First, a raw material is provided. Next, a pair of relative rollers are used to form the raw material into a plate optical component. The plate optical component has a first surface and a second surface opposite to the first surface. The first surface and the second surface respectively have a plurality of cylindrical convex portions, and the second surface further has a plurality of concave portions. Each of the concave portions is formed between the cylindrical convex portions of the second surface and is provided corresponding to the cylindrical convex portions of the first surface. Finally, a light absorbing material is applied to the concave portions.

As previously mentioned, since a surface of the optical component has concave portions between cylindrical convex potions and the light absorbing material is applied to the concave potions, the area of the light absorbing material can be increased without decreasing the brightness. Therefore, interference and scattered light from the environment can be efficiently absorbed, and the contrast and resolution can be improved. Moreover, the invention also provides a solution for applying the conventional light absorbing layer. Thus, the yield of the rear projection screen or optical component is substantially enhanced.

### BRIEF DESCRIPTION OF THE DRAWINGS

The invention will become more fully understood from the detailed description given hereinbelow illustration only, and thus are not limitative of the present invention, and wherein:

FIG. 1A is a schematic diagram showing a cross sectional view of the conventional rear projection screen;

FIG. 1B is a schematic diagram showing a partial view of the conventional rear projection screen and the incident light;

FIG. 1C is a schematic diagram showing a partial view of the conventional rear projection screen and the interference light;

FIG. 2A is a schematic diagram showing a cross sectional view of a rear projection screen according to a preferred embodiment of the invention;

FIG. 2B is a schematic diagram showing a partial view of the rear projection screen of the invention and the incident light;

FIG. 2C is a schematic diagram showing a partial view of the rear projection screen of the invention and the interference light;

FIG. 3 is a schematic diagram showing a cross sectional view of a rear projection screen according to another preferred embodiment of the invention, wherein the shape of each concave portion is an inverted triangle;

FIG. 4 is a schematic diagram showing a cross sectional view of a rear projection screen according to another preferred embodiment of the invention, wherein the shape of each concave portion is a trapezoid;

FIG. 5 is a schematic diagram showing a cross sectional view of a rear projection screen according to another preferred embodiment of the invention, wherein the second optical component has a plurality of light diffusing beads distributed inside;

FIG. 6 is a schematic diagram showing a cross sectional view of a rear projection screen according to another preferred embodiment of the invention, wherein the second optical component has a plurality of light diffusing beads distributed inside and an anti-static layer formed on the second surface;

FIG. 7 is a schematic diagram showing a cross sectional view of a rear projection screen according to another preferred embodiment of the invention, wherein the second optical component has a light diffusing layer and an anti-static layer formed on the second surface;

FIG. 8 is a schematic diagram showing a cross sectional view of a rear projection screen according to another preferred embodiment of the invention, wherein the second optical component has a plurality of light diffusing beads distributed inside, and has a light diffusing layer and an anti-static layer formed on the second surface;

FIG. 9 is a flow chart showing a method for manufacturing an optical component according to a preferred embodiment of the invention;

FIG. 10 is a flow chart showing a method for manufacturing an optical component according to another preferred embodiment of the invention; and

FIG. 11 is a flow chart showing a method for manufacturing an optical component according to yet another preferred embodiment of the invention.

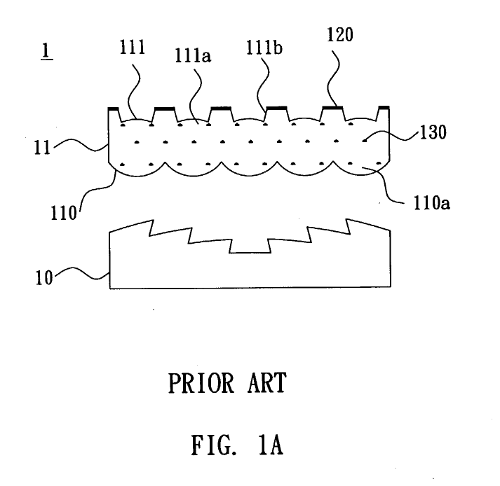

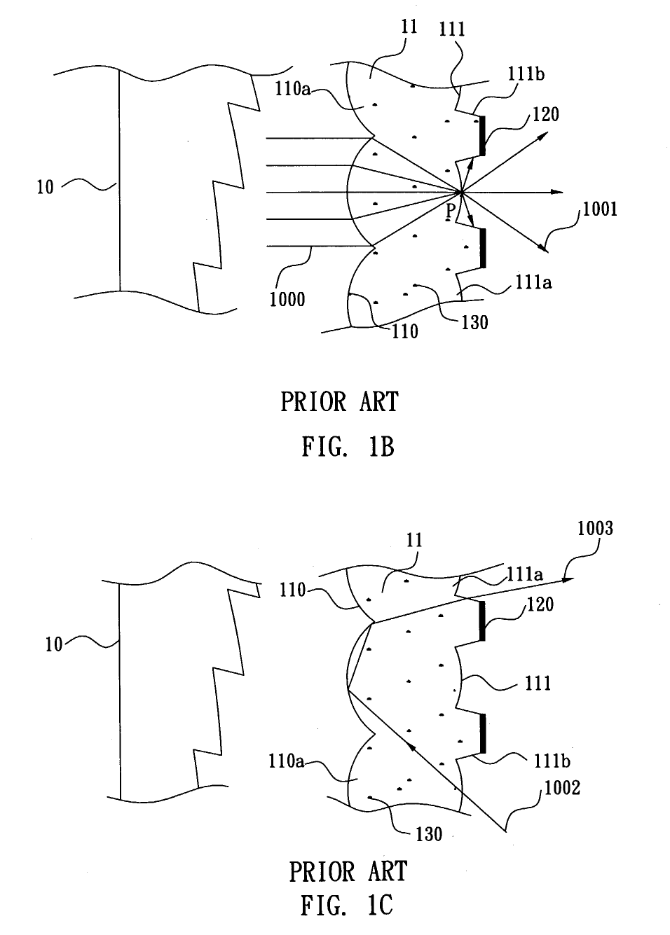

### DETAILED DESCRIPTION OF THE INVENTION

The rear projection screen, optical component used in the rear projection screen, and method for manufacturing the optical component according to the preferred embodiment of the invention will be described hereinbelow with reference to the accompany drawings, wherein the same reference numbers refer to the same elements.

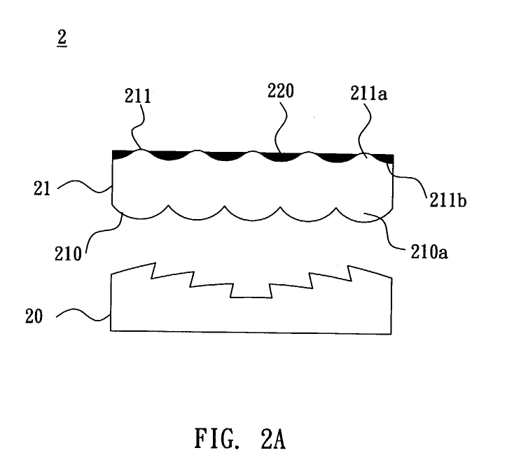

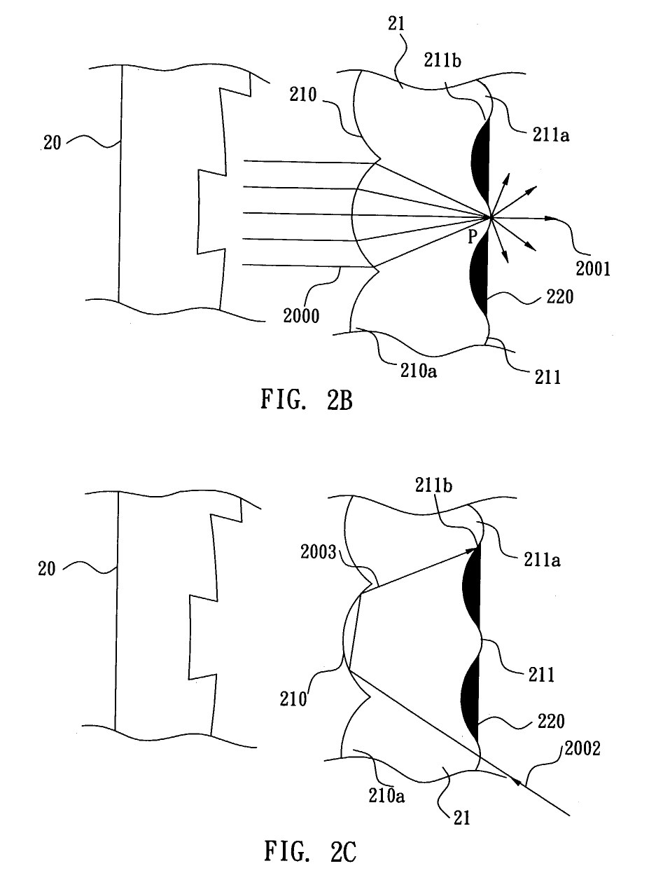

As shown in FIGS. 2A, 2B and 2C, a rear projection screen 2 according to a preferred embodiment of the invention includes a first optical component 20 and a second optical component 21.

The first optical component 20 is used for collecting light beams, so that diverging light beams can be focused and outputted to an audience. In the embodiment, the first optical component 20 can be a Fresnel lens. In this case, the light beams converge and are outputted in parallel from the first optical component 20.

The second optical component 21 has a first surface 210 and a second surface 211 opposite to the first surface 210. The first surface 210 is adjacent to the first optical component 20 and has a plurality of cylindrical convex portions 210a. The second surface 211 has a plurality of cylindrical convex portions 211a and a plurality of concave portions 211b, each of which is positioned between two adjacent cylindrical convex portions 211a. A light absorbing material 220 is applied to each concave portion 211b. As shown in FIG. 2A, each of the concave portions 21b is provided corresponding to each of the cylindrical convex portions 210a of the first surface 210. In the current embodiment, the second optical component 21 is a lenticular lens. Thus, people skilled in the art should understand that the intensity of light beams in a horizontal direction can be redistributed so as to increase the gain of the image center brightness. In addition, the angle of image brightness distributions can also be controlled.

As shown in FIG. 2B, the light absorbing material 220 of the invention is applied to each concave portion 211b, so the incident light 2000 reaches the first surface 210 in parallel and is focused on a spot (or a small region) of the cylindrical convex portion 211a of the second surface 211. Accordingly, the width of each concave portion 211b can be increased, and the area of light absorbing material 220 can be enlarged. In this case, the scattered light 2001 would not be blocked, and would not interfere with the brightness of the rear projection screen 2. Even if the thickness of the second optical component has an error as mentioned before, the scattered light 2001 will not be blocked by the light absorbing material 220. In addition, to decrease chromatic aberration or for any other purpose in optical design, the light beams may focus before or behind the second surface 211. Moreover, in a non-spherical lens, of which the majority are lenticular lenses, the second optical component 21 may be applied with an enlarged area of light absorbing material 220.

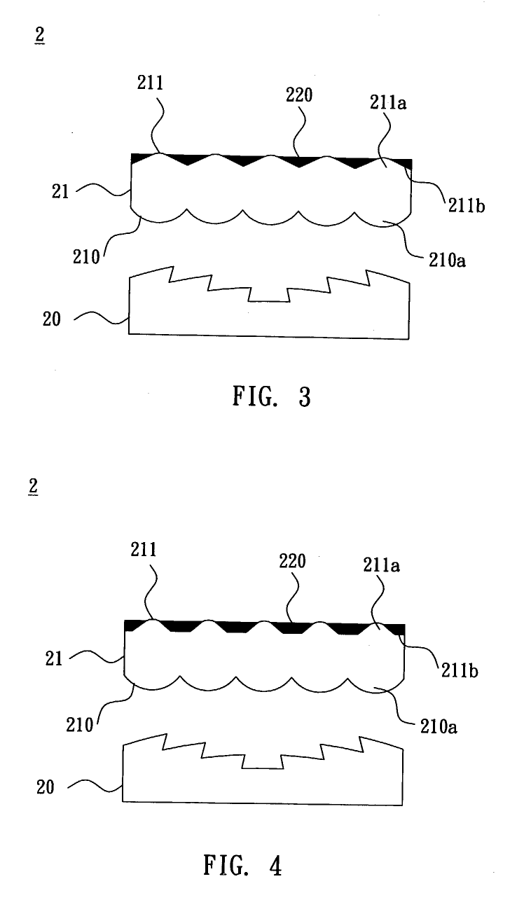

In addition, with reference to FIG. 2C, since the width of light absorbing material 220 is increased, the absorbing material 220 can more efficiently absorb the interference light 2002. Even though the interference light 2002 penetrates part of the second surface 211 which has not been applied with light absorbing material 220 and turns into the reflected light 2003, the reflected light 2003 will not penetrate the second surface 211 and will be absorbed by the absorbing material 220. Hence, the contrast and resolution of rear projection screen 2 can be improved efficiently. It should be noted that the shape of each concave portion 211b can be an arc, an inverted triangle (as shown in FIG. 3), a trapezoid (as shown in FIG. 4), or the likes.

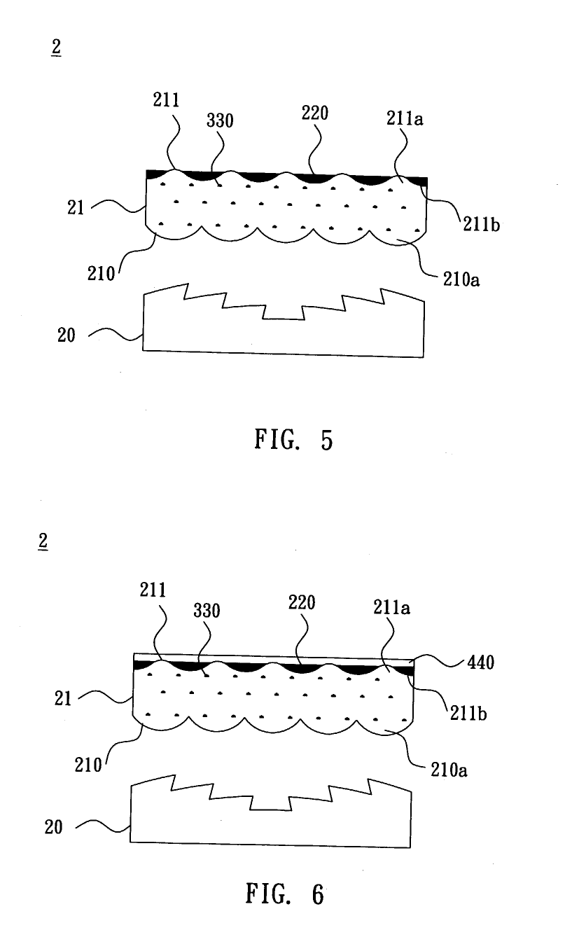

With reference to FIG. 5, the second optical component 21 can further have a plurality of light diffusing beads 330 distributed inside. In this case, the view angle of rear projection screen 2 can be increased accordingly.

Furthermore, as shown in FIG. 6, an anti-static layer 440 is formed on the second surface 211 and absorbing material 220 of the second optical component 21. It should be noted that people skilled in the art could replace the anti-static layer 440 with an anti-reflection layer, an anti-scratch layer, or two or more layers selected from the group consisting of an anti-static layer, an anti-reflection layer, and an anti-scratch layer.

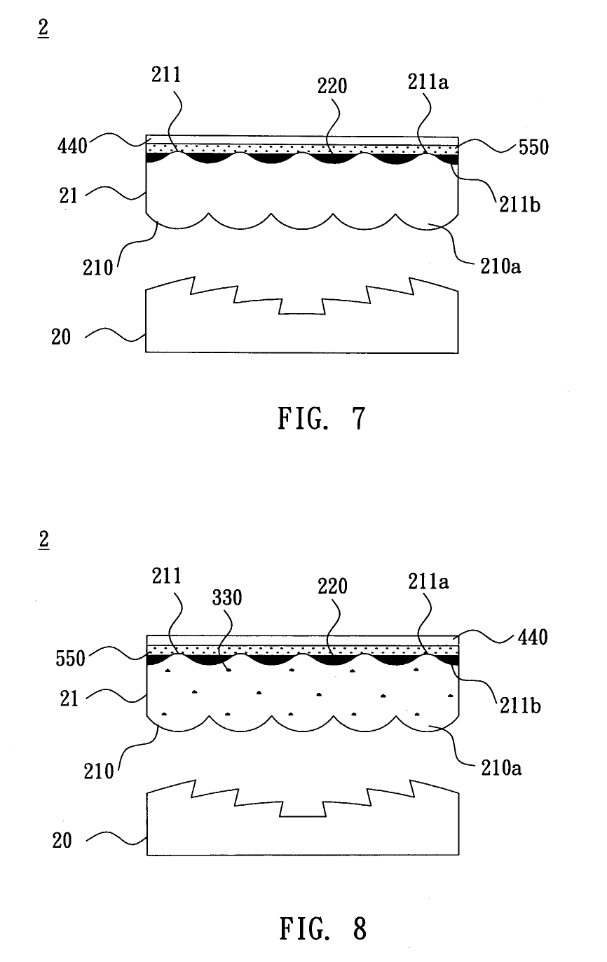

Alternatively, as shown in FIG. 7, the second optical component 21 can have a light diffusing layer 550 formed on the second surface 211 and light absorbing material 220. In the current embodiment, the view angle of rear projection screen 2 can also be increased. Similarly, an anti-static layer 440 can be formed on the second surface 211 and absorbing material 220 of the second optical component 21, and it can be replaced by an anti-reflection layer, an anti-scratch layer, or two or more of the above mentioned layers.

Referring to FIG. 8, the second optical component 21, according to another embodiment of the invention, can have light diffusing beads 330 mixed inside and a light diffusing layer 550 formed on the second surface 211 and light absorbing material 220. In the present embodiment, the view angle of rear projection screen 2 can be increased, and the brightness of that can also become more uniform. Moreover, an anti-static layer 440 can be formed on the light diffusing layer 550 for further enhancing the quality of rear projection screen 2. It should be noted that people skilled in the art could replace the anti-static layer 440 with an anti-reflection layer, an anti-scratch layer, or two or more layers selected from the group consisting of an anti-static layer, an anti-reflection layer, and an anti-scratch layer.

This invention also discloses an optical component, which is similar to the mentioned second optical component 21 of rear projection screen 2. Thus, this specification would not illustrate it in more detail herein below.

The present invention is described in greater detail with reference to the following embodiment, which illustrates a method for manufacturing an optical component.

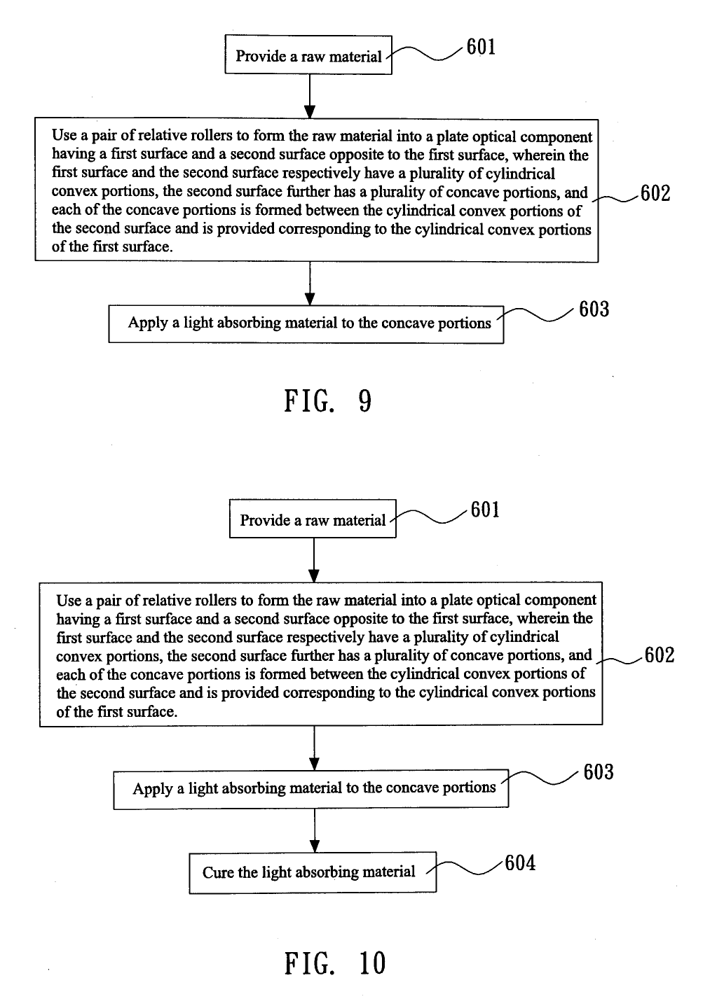

Please refer to FIG. 9. First, in step 601, a raw material is provided. In the embodiment, the raw material can be made of polymethyl methacrylate (PMMA), polyethylene terephthalate glycol (PETG), polystyrene (PS), polycarbonate (PC), or any other copolymer. It should be noted that the raw material can be premixed with light diffusing materials such as light diffusing beads.

Next, in step 602, a pair of relative rollers are used to form the raw material into a plate optical component having a first surface and a second surface opposite to the first surface. In the invention, the first surface and the second surface respectively have a plurality of cylindrical convex portions, and the second surface further has a plurality of concave portions. Each of the concave portions is formed between the cylindrical convex portions of the second surface and is provided corresponding to the cylindrical convex portions of the first surface. It should be noted that the shape of each concave portion can be an arc, an inverted triangle, a trapezoid, or the like.

In step 603, a light absorbing material is applied to the concave portions. In the present embodiment, the light absorbing material is a dark printing ink, and it can be applied by utilizing a roller coating method, a dipping coating method, or curtain coating method.

Furthermore, as shown in FIG. 10, the method for manufacturing an optical component further includes a step 604 for curing the light absorbing material. In this embodiment, the absorbing material can be cured with an UV curing method, a thermal curing method, or a thermal drying method.

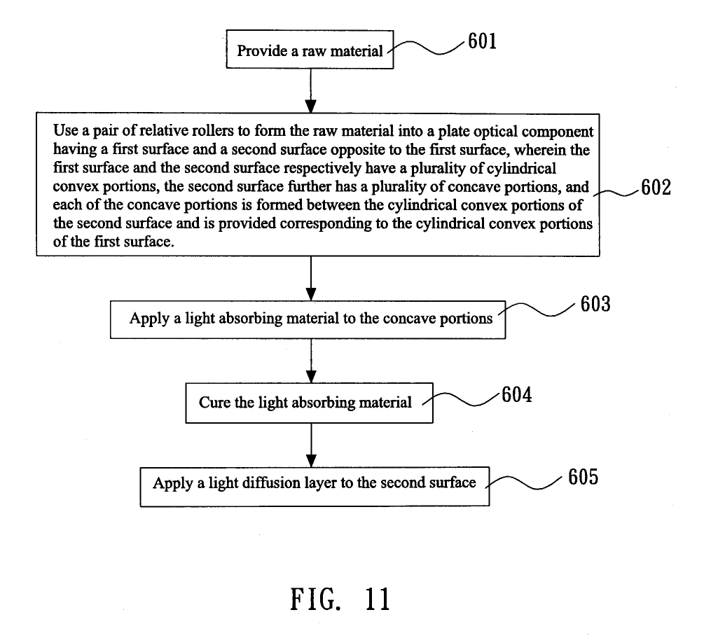

With reference to FIG. 11, the method for manufacturing an optical component still further includes a step 605 for applying a light diffusion layer to the second surface. In this case, the light diffusing layer can be applied with conventional roller printing method. Alternatively, the light diffusing layer can be a film and be attached to the second surface.

In summary, since the second optical component of a rear projection screen or the optical component of the invention has a second surface which has concave portions located between the cylindrical convex portions and has a light absorbing material applied to the concave portions, the region of light absorbing material can be increased to 70% or more area of the second surface. Compared with the conventional stripe convexes, the light absorbing material of the invention has increased in area, so that the rear projection screen of the invention has improved contrast, resolution, and brightness. In addition, in the manufacturing process, since the light absorbing material of the invention is applied to the concave portions of the optical component, the critical and accurate controls for the planarity of conventional stripe convex and for the pressure controlling of printing can be avoided. Thus, the yield of the rear projection screen and optical component of the invention can be increased.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A rear projection screen, comprising:
a first optical component; and
a second optical component, which is adjacent to the first optical component and has a first surface and a second surface opposite to the first surface, the first surface and the second surface respectively having a plurality of cylindrical convex portions, the second surface further having a plurality of concave portions, each of the concave portions being formed between the cylindrical convex portions of the second surface, being provided corresponding to the cylindrical convex portions of the first surface, and being applied with a light absorbing material.

2. The rear projection screen of claim 1, wherein the first surface of the second optical component is adjacent to the first optical component.

3. The rear projection screen of claim 1, wherein the first optical component is a Fresnel lens, and the second optical component is a lenticular lens.

4. The rear projection screen of claim 1, wherein the shape of the concave portions of the second optical component is a trapezoid.

5. The rear projection screen of claim 1, wherein the shape of the concave portions of the second optical component is an inverted triangle.

6. The rear projection screen of claim 1, wherein the shape of the concave portions of the second optical component is an arc.

7. The rear projection screen of claim 1, wherein the second optical component is mixed with light diffusing beads.

8. The rear projection screen of claim 1, wherein a light diffusing layer is formed on the second surface of the second optical component.

9. The rear projection screen of claim 1, wherein the second optical component is mixed with a light diffusing material, and a light diffusing layer is applied to the second surface of the second optical component.

10. The rear projection screen of claim 1, wherein an anti-static layer is formed on the second surface of the second optical component.

11. The rear projection screen of claim 1, wherein an anti-scratch layer is formed on the second surface of the second optical component.

12. The rear projection screen of claim 1, wherein an anti-reflection layer is formed on the second surface of the second optical component.

13. An optical component having a first surface and a second surface opposite to the first surface, wherein the first surface and the second surface respectively have a plurality of cylindrical convex portions, the optical component being characterized in that:
the second surface further has a plurality of concave portions, each of the concave portions being formed between the cylindrical convex portions of the second surface, being provided corresponding to the cylindrical convex portions of the first surface, and being applied with a light absorbing material.

14. The optical component of claim 13, wherein the shape of the concave portions of the optical component is a trapezoid.

15. The optical component of claim 13, wherein the shape of the concave portions of the optical component is an inverted triangle.

16. The optical component of claim 13, wherein the shape of the concave portions of the optical component is an arc.

17. The optical component of claim 13, wherein the optical component is mixed with light diffusing beads.

18. The optical component of claim 13, wherein a light diffusing layer is applied to the second surface of the optical component.

19. The optical component of claim 13, wherein the optical component is mixed with a light diffusing material, and a light diffusing layer is applied to the second surface of the optical component.

20. A method for manufacturing an optical component, comprising:
providing a raw material of the optical component;
using a pair of relative rollers to form the raw material into a plate optical component having a first surface and a second surface opposite to the first surface, the first surface and the second surface respectively having a plurality of cylindrical convex portions, the second surface further having a plurality of concave portions, each of the concave portions being formed between the cylindrical convex portions of the second surface and being provided corresponding to the cylindrical convex portions of the first surface; and
applying a light absorbing material to the concave portions.

21. The method of claim 20, wherein the raw material is mixed with light diffusing beads.

22. The method of claim 20, wherein the light absorbing material is applied by utilizing a roller coating method.

23. The method of claim 20, further comprising:
curing the light absorbing material.

24. The method of claim 20, further comprising:
applying a light diffusion layer to the second surface.
